(19) United States
(12) Patent Application Publication
(10) Pub. No.: US 2026/0088613 A1
(43) Pub. Date: Mar. 26, 2026

(54) SCHEDULING METHOD, SYSTEM, ELECTRONIC DEVICE, AND MEDIUM FOR ADDRESSING POWER SHORTAGE

(71) Applicant: Beijing Jiaotong University, Beijing (CN)

(72) Inventors: Zhao LIU, Beijing (CN); Xiaojun WANG, Beijing (CN); Fangyuan SI, Beijing (CN); Zhijie JIAO, Beijing (CN); Min CHEN, Beijing (CN); Jinghan HE, Beijing (CN); Ying WANG, Beijing (CN)

(73) Assignee: Beijing Jiaotong University, Beijing, BJ (CN)

(21) Appl. No.: 19/403,839

(22) Filed: Nov. 29, 2025

(30) Foreign Application Priority Data
Dec. 10, 2024 (CN) 202411811423.1

(51) Int. Cl. H02J 3/00; G06Q 50/06

(52) U.S. Cl. CPC H02J 3/001; G06Q 50/06; H02J 3/003; H02J 3/004; H02J 2101/22; H02J 2103/30; H02J 2105/42

(57) ABSTRACT

The present disclosure provides a scheduling method, system, electronic device, and medium for addressing power shortages, comprising: step S1: classifying demand-side flexible resources; step S2: constructing a day-ahead-and-intraday optimization scheduling mechanism for demand-side resources to participate in system regulating; step S3: modeling demand-side flexible resources; step S4: aggregating regulating abilities of the Class II load; and step S5: constructing an intraday optimization scheduling model based on a total cost of purchasing electricity from other power grids and a total cost of dispatching load-side resources. The present disclosure classifies demand-side resources and constructs an optimization scheduling mechanism, effectively dispatching different types of regulating resources to participate in optimization scheduling, balancing cost of purchasing electricity from outside the province and dispatching resources within the province, considering uncertainty of adjustability of distributed resources making the model more accurate and practical, thereby reducing cost of scheduling during power shortage.

### CROSS-REFERENCE TO RELATED APPLICATION

This application claims priority to Chinese Patent Application No. 202411811423.1, filed on Dec. 10, 2024, which is hereby incorporated by reference in its entirety.

### TECHNICAL FIELD

The present disclosure relates to the technology field of demand-side resource allocation and optimization scheduling, particularly to scheduling method, system, electronic device, and medium for addressing power shortage.

### BACKGROUND ART

With acceleration of clean energy transformation, the power system is increasingly integrating more renewable energies, especially photovoltaic and wind power. The power generation capacity of these renewable energies is highly dependent on local real-time weather conditions, and variability and uncertainty of weather, especially frequent occurrence of extreme weather events in recent years, greatly increase the difficulty of achieving power balance of generation and demand in new-type power systems with a high proportion of access of renewable energies, which may lead to significant gaps in intraday electricity supply and demand. When the reserve regulating capability within the system is limited, in order to maintain the normal operation of the system, it is necessary to rely on the real-time market and purchase electricity from other power grids at potentially higher prices, which undoubtedly poses a serious challenge to the economy and operation of power systems.

In this context, the demand side is increasingly received attention due to its enormous regulatory and response potential. Although some studies have been made in the modeling, aggregation, construction of economic optimization scheduling model, and system supply-demand balance evaluation system of demand-side flexible resources, most of these studies remain at the theoretical level and have not fully explored characteristics of demand-side flexible resources, nor have they been able to targetedly construct dispatching mechanisms and optimization scheduling methods suitable for practical scheduling systems.

With continuous increase of the proportion of renewable energy in the power system, the difficulty of predicting the output on the source side is increasing, and the uncertainty on both the source and load sides further exacerbates the difficulty of balancing power. In the face of potential intraday power shortages, the current practical solutions mainly include dispatching for system reserve, purchasing electricity from other power grids, and implementing orderly electricity consumption. However, the increase in system reserve capacity is not an one-time effort. When the reserve capacity is insufficient to make up for a large power shortage, the high cost of purchasing electricity becomes an unavoidable problem.

Numerous studies have shown that the demand side of the power system has enormous regulatory potential, which can provide strong support for flexible regulating of the system. However, current studies still mainly focus on modeling and aggregation of demand-side flexible resources, and construction of optimization scheduling models. Effective scheduling mechanisms have not yet been established according to unique characteristics of various types of demand-side flexible resources, nor have optimization scheduling methods directly applicable to practical scheduling systems been formed. Therefore, future studies should explore the potential of demand-side flexible resources, construct more accurate and efficient scheduling mechanisms and methods to address challenges brought by the increase in the proportion of access of renewable energies.

### SUMMARY

The purpose of the present disclosure is to provide scheduling method, system, electronic device, and medium for addressing power shortage. By classifying demand-side resources and constructing an optimization scheduling mechanism, different types of regulating resources are effectively dispatched to participate in optimization scheduling, balancing the cost of purchasing electricity from outside the province and dispatching resources within the province, considering the uncertainty of the adjustability of distributed resources, making the model more accurate and practical, thereby reducing the cost of scheduling during power shortages.

To achieve the above objectives, the present disclosure provides a scheduling method for addressing power shortage, including following steps:
step S1: classifying demand-side flexible resources, where the demand-side flexible resources includes industrial load, residential load, and commercial load, and where the industrial load is Class I load, and the residential load and commercial load are Class II load;
step S2: according to a classification result of the demand-side flexible resources, constructing a day-ahead-and-intraday optimization scheduling mechanism for demand-side resources to participate in system regulating;
step S3: modeling demand-side flexible resources;
step S4, aggregating regulating abilities of the Class II load; and
step S5: constructing an intraday optimization scheduling model based on a total cost of purchasing electricity from other power grids and a total cost of dispatching load-side resources;

In some embodiments, the day-ahead-and-intraday optimization scheduling mechanism for demand-side resources to participate in system regulating includes:
in a day-ahead stage, a probability of source-load balance and a reserve capacity may be needed to be dispatched are inferred by a scheduling center according to predicted results of renewable energy and load, combined with a probability of different weather conditions; information of the predicted results and the reserve capacity is sent to a marketing department, which splits a shortage into two parts as a basis for forecasting the Class I load and the Class II load, respectively; an optimized calculation is performed by the scheduling center according to a forecast of the Class I load and the Class II load, and a calculation result is distributed to a user;
in an intraday stage, when user-side resources are needed to be dispatched, the user is notified according to the distributed calculation result to respond; when user-side resources are not needed to participate, the user is not notified.

In some embodiments, in step S3, the modeling demand-side flexible resources includes constructing a model of the Class I load and a model of the Class II load;
where constraints of the model of the Class I load include:
a power-balance constraint:

$${P}_{i , s , adj}^{t} = {P}_{i , s , base}^{t} - {P}_{i , s}^{t} ; \qquad ( 1 )$$

a power-regulating constraint:

$${P}_{i , s , adj}^{min} \leq {P}_{i , s , adj}^{t} \leq {P}_{i , s , adj}^{max} ; \qquad ( 2 )$$

an actual-demand-power constraint:

$${P}_{i , s}^{min} \leq {P}_{i , s}^{t} \leq {P}_{i , s}^{max} ; \qquad ( 3 )$$

a climbing constraint:

$${r}_{i , s}^{min} \leq {P}_{i , s}^{t} - {P}_{i , s}^{t - 1} \leq {r}_{i , s}^{max} ; \qquad ( 4 )$$

an energy-consumption constraint

$${E}_{i , s}^{min} \leq {\sum }_{k = 1}^{N} {P}_{i , s}^{{t}_{k}} \cdot ( {t}_{k} - {t}_{k - 1} ) \leq {E}_{i , s}^{max} ; \qquad ( 5 )$$

where

$${P}_{i , s , adj}^{t}$$

represents a regulating power of Class I load s on node i participating in demand response at moment t;

$${P}_{i , s , base}^{t}$$

represents a required power of Class I load s on node i not participating in demand response at moment t;

$${P}_{i , s}^{t}$$

represents an actual required power of

Class I load s on node i after participating in regulating at moment t;

$${P}_{i , s}^{t - 1}$$

represents an actual required power of Class I load s on node i after participating in regulating at moment t−1;

$${P}_{i , s , adj}^{max} and {P}_{i , s , adj}^{min}$$

represent an upper limit and a lower limit of a regulating power of Class I load s on node i participating in demand response, respectively;

$${P}_{i , s}^{max} and {P}_{i , s}^{min}$$

represent an upper limit and a lower limit of an actual required power of Class I load s on node i respectively, depending on a maximum transmission power of a circuit;

$${r}_{i , s}^{max} and {r}_{i , s}^{min}$$

represent an upper limit and a lower limit of a regulating rate of Class I load s on node i, respectively;

$${E}_{i , s}^{max} and {E}_{i , s}^{min}$$

represent electric energy required for a production plan with a maximum load and electric energy required for a production plan with a minimum load during a period of t₀˜t_{N}, respectively; N represents a number of calculated moments; k represents a moment number; tₖ represents a k th moment; tₖ₋₁ represents a k−1 moment; s∈{Steel,SiC,Cement}, and where Steel represents a steel load, SiC represents a silicon-carbide industrial load, and Cement represents a cement processing load;
where the model of the Class II load includes a model of general resource, a model of air-conditioning load, and a model of residential water-heater load;
where for the model of general resource, a probability of user participating in power system scheduling on node i under policy incentives is P_{i,h}^{t}, and a power of user participating in regulating of power system on node i at moment t is expressed as:

$${P}_{i , h , adj}^{t} = {p}_{i , h}^{t} \cdot Δ {P}_{i , h}^{t} ; \qquad ( 6 )$$

$${Q}_{i , h , adj}^{t} = {p}_{i , h}^{t} \cdot Δ {Q}_{i , h}^{t} ; \qquad ( 7 )$$

$$0 \leq {p}_{i , h}^{t} \leq 1 ; \qquad ( 8 )$$

where

$${P}_{i , h , adj}^{t} and {Q}_{i , h , adj}^{t}$$

represent an active power and a reactive power of Class II load h on node i actually participating in regulating at moment t, respectively; and

$$Δ {P}_{i , h}^{t} and Δ {Q}_{t , h}^{t}$$

represent a maximum active regulating power and a maximum reactive regulating power of Class II load h on node i that can participate in regulating at moment t, respectively;
where an actual online load of user on node i includes:

$${P}_{i , h}^{t} = {P}_{i , h , base}^{t} - {P}_{i , h , adj}^{t} ; \qquad ( 9 )$$

$${Q}_{i , h}^{t} = {Q}_{i , h , base}^{t} - {Q}_{i , h , adj}^{t} ; \qquad ( 10 )$$

where

$${P}_{i , h , b a s e}^{t} and {Q}_{i , h , base}^{f}$$

represent an active power demand and a reactive power demand of Class II load h on node i not participating in regulating at moment t, respectively; and

$${P}_{i , h}^{t} and {Q}_{i , h}^{t}$$

represent an active-power actual demand power and a reactive-power actual demand power of Class II load h on node i after participating in regulating at moment t, respectively;
for the model of air-conditioning load, it is assumed that an indoor temperature of an air-conditioning user on node i completely participating in regulating at moment t is

$${T}_{i , in}^{t ′} ,$$

then an adjustment amount of an indoor temperature of the air-conditioning user is represented by

$$Δ {T}_{i , in}^{t ′} = {T}_{i , in}^{t ′} - {T}_{i , in}^{t} ,$$

where

$${T}_{i , in}^{t}$$

represents an indoor temperature of an air-conditioning user on node i not participating in regulating at moment t, and where a relationship between a variation in state of charge

$$Δ {SOC}_{i , h ( airc )}^{t ′}$$

and a variation in power consumption

$$Δ {P}_{i , h ( airc )}^{t ′}$$

corresponding to the adjustment amount of the indoor temperature is expressed as:

$$\begin{matrix}Δ {SOC}_{i , h ( airc )}^{t ′} = Δ {SOC}_{i , h ( airc )}^{t ′} - Δ {SOC}_{i , h ( airc )}^{t} \\ = \frac{Δ {T}_{i , in}^{t ′}}{{T}_{i , max} - {T}_{i , min}} ;\end{matrix} \qquad ( 11 )$$

$$\begin{matrix}Δ {SOC}_{i , h ( airc )}^{t + 1 ′} = {SOC}_{i , h ( airc )}^{t + 1 ′} - {SOC}_{i , h ( airc )}^{t + 1} \\ = {a}_{1} Δ {SOC}_{i , h ( airc )}^{t ′} + {a}_{2} Δ {P}_{i , h ( airc )}^{t ′} + {a}_{3} Δ {P}_{i , h ( airc )}^{t + 1 ′} ;\end{matrix} \qquad ( 12 )$$

where

$${SOC}_{i , h ( airc )}^{t}$$

represents a state of charge of an air-conditioning user on node i not participating in regulating at moment t;

$${SOC}_{i , h ( airc )}^{t ′}$$

represents a state of charge of air-conditioning user on node i completely participating in regulating at moment t; T_{i,max} and T_{i,min} represent a maximum adjustable temperature and a minimum adjustable temperature of an air conditioner on node i, respectively;

$$Δ {P}_{i , h ( airc )}^{t ′}$$

represents a power variation of an air-conditioning load on node i participating in regulating at moment t; α₁, α₂ and α₃ all represent model parameters;

$${SOC}_{i , h ( airc )}^{t + 1 ′} , {SOC}_{i , h ( airc )}^{t + 1 ′} , {SOC}_{i , h ( airc )}^{t + 1} , and Δ {P}_{i , h ( airc )}^{t + 1 ′}$$

represent a state of

$$Δ S O {C}_{i , h ( airc )}^{t ′}$$

at moment t+1, a state of

$${SOC}_{i , h ( airc )}^{t ′}$$

at moment t+1, a state of

$${SOC}_{i , h ( airc )}^{t}$$

moment t+1, and a state of

$$Δ {P}_{i , h ( airc )}^{t ′}$$

at moment t+1, respectively;
where it is considered that a probability of user participating in regulating is influenced by differences in psychology of participation of user individuals, when a participation probability of user

$${p}_{i , h ( airc )}^{t}$$

introduced, an actual power consumption of the air-conditioning load

$${P}_{i , h ( airc )}^{t}$$

is represented by:

$${P}_{i , h ( airc )}^{t} = {P}_{base , i , h ( airc )}^{t} - {p}_{i , h ( airc )}^{t} \cdot Δ {P}_{i , h ( airc )}^{t ′} ; \qquad ( 13 )$$

where P_{base,i,h(aire)}^{t} represents a power required by the air-conditioning load on node i not participating in demand response at moment t;
for the model of the residential water-heater load, it is assumed that a heating upper-limit temperature of a water heater of a user having a residential water-heater load on node i completely participating in regulating at moment t is an upper-limit temperature of the water heater

$${T}_{i , h ( rwh )}^{max} ,$$

then an adjustment amount of temperature of the residential water-heater load on node i participating in regulating at moment t is represented by

$$Δ {T}_{i , h ( rwh )}^{t ′} = {T}_{i , h ( rwh )}^{max} - {T}_{i , h ( rwh )}^{t} ;$$

where

$${T}_{i , h ( rwh )}^{t}$$

represents an upper-limit temperature set by the water heater when the user having residential water-heater load on node i not participating in regulating at moment t, and where a relationship between a variation in state of charge

$$Δ S O {C}_{i , h ( rwh )}^{t ′}$$

and a variation in power consumption

$$Δ {P}_{i , h ( rwh )}^{t ′}$$

corresponding to the adjustment amount of the residential water-heater temperature is expressed as:

$$Δ S O {C}_{i , h ( rwh )}^{t ′} = S O {C}_{i , h ( rwh )}^{t ′} - S O {C}_{i , h ( rwh )}^{t} = 1 - \frac{{T}_{i , h ( rwh )}^{T}}{{T}_{i , h ( rwh )}^{max}} ; \qquad ( 14 )$$

$$Δ S O {C}_{i , h ( rwh )}^{t + 1 ′} = S O {C}_{i , h ( rwh )}^{t + 1 ′} - S O {C}_{i , h ( rwh )}^{t + 1} = {a}_{t} Δ S O {C}_{i , h ( rwh )}^{t ′} - \frac{{b}_{t}}{{T}_{i , h ( rwh )}^{max}} Δ {P}_{i , h ( rwh )}^{t ′} ; \qquad ( 15 )$$

where

$$S O {C}_{i , h ( rwh )}^{t}$$

represents a state of charge of a water heater corresponding to

$${T}_{i , h ( rwh )}^{t}$$

when the residential water-heater load on node i not participating in regulating at moment t;

$$Δ S O {C}_{i , h ( rwh )}^{t ′}$$

represents a state of charge of the water heater corresponding to

$${T}_{i , h ( rwh )}^{max}$$

when the residential water-heater load on node i completely participating in regulating at moment t; αₜ and bₜ represent unit parameters of a water-heater modular unit, respectively; and

$$Δ S O {C}_{i , h ( rwh )}^{t + 1 ′} , S O {C}_{i , h ( rwh )}^{t + 1 ′} , and S O {C}_{i , h ( rwh )}^{t + 1}$$

represent a state of

$$Δ S O {C}_{i , h ( rwh )}^{t ′}$$

at moment t+1, a state of

$$S O {C}_{i , h ( rwh )}^{t′}$$

at moment t+1, and a state of

$$S O {C}_{i , h ( rwh )}^{t}$$

at moment t+1, respectively.

In some embodiment, in step S4, the aggregating regulating abilities of the Class II load includes:
determining a space formed by an aggregated power adjustment range of the Class II load as R²ⁿ; where n represents a number of flexible resources;
solving a projection by using a vertex search method, where the projection is a feasible region of a convex polygon;
by changing optimization directions of an objective function, solving optimization problems under different objective functions, gradually extrapolating and obtaining a boundary of the convex polygon; where an objective function for solving the projection is expressed as:

$$max \{ μ {x}_{pcc}^{t} , {x}_{pcc}^{t} ∈ {Ω}_{pcc}^{t} \} ; \qquad ( 16 )$$

where μ=(μ_{P}, μ_{Q}) represents a direction vector in space R² and is determined by a normal vector of a boundary of an initial convex polygon;

$${x}_{pcc}^{t} = {( {P}_{pcc} , {Q}_{pcc} )}^{T}$$

represents a point within a feasible region

$${Ω}_{pcc}^{t} ;$$

P_{pcc} and Q_{pcc} represent a projected active power and a projected reactive power on a connection circuit between an aggregate and a power grid, respectively;
where constraints for solving the projection include constraints of adjustable output force constraints and power flow constraints of a connected network of each flexible resource;
solving an optimization problem, searching for a new vertex along a direction of a normal vector of each edge of the initial convex polygon; where when a distance lₖ between the new vertex and an original edge is less than a constant value l_{δ}, a process of the solving is ended, and a condition of ending is expressed as:

$${l}_{k} = \frac{\vert M \cdot {P}_{pcc 0} + N \cdot {Q}_{pcc 0} + C \vert}{\sqrt{{M}^{2} + {N}^{2}}} \leq {l}_{δ} ; \qquad ( 17 )$$

where

$${x}_{pcc 0}^{t} = ( {P}_{pcc 0} , {Q}_{pcc 0} )$$

represents a coordinate of the new vertex; parameters M, N, and C are determined by a primary-side equation M·P_{cc0}+N·±Q_{pcc0}+C=0; and P_{cc0} and Q_{pcc0} represent newly solved projected active power and newly solved projected reactive power on the connection circuit between the aggregate and the power grid, respectively.

In some embodiment, in step S5, the intraday optimization scheduling model is as follows:

$$min {C}^{t} = {C}_{G}^{t} + {C}_{L}^{t} ; \qquad ( 18 )$$

$${C}_{G}^{t} = {\sum }_{{j}_{1}} {c}_{{j}_{1} , g}^{t} {P}_{{j}_{1} , g , adj}^{t} ; \qquad ( 19 )$$

$${C}_{L}^{t} = {C}_{L 1}^{t} + {C}_{L 2}^{t} = {\sum }_{{j}_{2}} {c}_{{j}_{2} , L 1}^{t} {P}_{{j}_{2} , L 1 , adj}^{t} + {\sum }_{{j}_{3}} {c}_{{j}_{3} , L 2}^{t} {P}_{{j}_{3} , L 2 , adj}^{t} ; \qquad ( 20 )$$

$${P}_{lack} = {\sum }_{{j}_{1}} {P}_{{j}_{1} , g , adj}^{t} + {\sum }_{{j}_{2}} {P}_{{j}_{2} , L 1 , adj}^{t} + {\sum }_{{j}_{3}} {P}_{{j}_{3} , L 2 , adj}^{t} ; \qquad ( 21 )$$

$$- {P}_{{j}_{1} , g , adj}^{max} \leq {P}_{{j}_{1} , g , adj}^{t} \leq {P}_{{j}_{1} , g , adj}^{max} ; \qquad ( 22 )$$

$${P}_{{j}_{2} , L 1 , adj}^{min} \leq {P}_{{j}_{2} , L 1 , adj}^{t} \leq {P}_{{j}_{2} , L 1 , adj}^{max} ; \qquad ( 23 )$$

$${P}_{{j}_{3} , L 2 , adj}^{min} \leq {P}_{{j}_{3} , L 2 , adj}^{t} \leq {P}_{{j}_{3} , L 2 , adj}^{max} ; \qquad ( 24 )$$

$${P}_{lack} \leq {\sum }_{{j}_{1}} {P}_{{j}_{1} , g , adj}^{max} + {\sum }_{{j}_{2}} {P}_{{j}_{2} , L 1 , adj}^{max} + {\sum }_{{j}_{3}} {P}_{{j}_{3} , L 2 , adj}^{max} ; \qquad ( 25 )$$

$$\{ \begin{matrix}{P}_{j} = {\sum }_{i ∈ {φ}_{j 1}} ( {P}_{ij} - {r}_{ij} {l}_{ij} ) - {\sum }_{k ∈ {φ}_{j 2}} {P}_{jk} \\ {Q}_{j} = {\sum }_{i ∈ {φ}_{j 1}} ( {Q}_{ij} - {x}_{ij} {l}_{ij} ) - {\sum }_{k ∈ {φ}_{j 2}} {Q}_{jk} \\ {V}_{j}^{2} = {V}_{i}^{2} - 2 ( {r}_{ij} {P}_{ij} + {x}_{ij} {Q}_{ij} ) + ( {r}_{ij}^{2} + {x}_{ij}^{2} ) {I}_{ij}^{2} \\ {‖ \begin{matrix}2 {P}_{ij} \\ 2 {Q}_{ij} \\ {I}_{ij}^{2} - {V}_{i}^{2}\end{matrix} ‖}_{2} \leq {I}_{ij}^{2} + {V}_{i}^{2} \\ {V}_{min} \leq {V}_{i} \leq {V}_{max} \\ {I}_{min} \leq {I}_{ij} \leq {I}_{max}\end{matrix} ; \qquad ( 26 )$$

where C′ represents a total cost at moment t;

$${C}_{G}^{t}$$

represents a total cost of purchasing electricity from other power grids;

$${C}_{L}^{t}$$

represents a total cost of dispatching load-side resources; j₁, j₂, and j₃ represent sets of nodes connected to other power grids, Class I load, and Class II load, respectively;

$${c}_{{j}_{1} , g}^{t} , {c}_{{j}_{2} , L 1}^{t} , and {c}_{{j}_{3} , L 2}^{t}$$

represent price of electricity purchased from other power grids, Class I load, and Class II load, respectively;

$${P}_{{j}_{1} , g , adj}^{t} , {P}_{{j}_{2} , L 1 , adj}^{t} , and {P}_{{j}_{3} , L 2 , adj}^{t}$$

represent electricities purchased from other power grids, Class I load, and Class II load, respectively; P_{lack} represents a power shortage in a system;

$${P}_{{j}_{1} , g , adj}^{max} , {P}_{{j}_{2} , L 1 , adj}^{max} , and {P}_{{j}_{3} , L 2 , adj}^{max}$$

represent upper limits of regulating capacity for other power grids, Class I load, and Class II load, respectively;

$${P}_{{j}_{2} , L 1 , adj}^{min} and {P}_{{j}_{3} , L 2 , adj}^{min}$$

represent lower limits of regulating capacity for Class I load and Class II load, respectively; Pⱼ and Qⱼ represent an active power and a reactive power injected into a node j, respectively; Pᵢⱼ and Qᵢⱼ represent an active power and a reactive power injected into a circuit ij, respectively; rᵢⱼ, xᵢⱼ, and lᵢⱼ represent a resistance per unit, a reactance per unit, and a length of circuit ij, respectively; Vᵢ, Vₘₐₓ, and Vₘᵢₙ represent a voltage, a maximum voltage, and a maximum carrying current, and a minimum carrying current of circuit ij, respectively; φⱼ₁ represents a set of upstream nodes of node j; and φⱼ₂ represents a set of downstream nodes of node j.

The present disclosure also provides a scheduling system for addressing power shortage, including:
a resource classification module, configured for classifying demand-side flexible resources, where the the demand-side flexible resources includes Class I load and Class II load;
a scheduling-mechanism construction module, configured for constructing a day-ahead-and-intraday optimization scheduling mechanism for demand-side resources to participate in system regulating according to a classification result of demand-side flexible resources;
a resource modeling module, configured for modeling demand-side flexible resources, where the modeling includes constructing a model of the Class I load and a model of the Class II load;
an adjustment capability aggregation module, configured for aggregating regulating abilities of the Class II load; and
an intraday optimization scheduling model module, configured for constructing an intraday optimization scheduling model based on a total cost of purchasing electricity from other power grids and a total cost of dispatching load-side resources.

The present disclosure further provides a computer device including a processor and a memory storing a computer program, where when the processor executes the computer program, steps of the aforementioned scheduling method for addressing power shortage are implemented.

The present disclosure further provides a computer-readable storage medium storing a computer program, where when the computer program is executed by a processor, steps of the aforementioned scheduling method for addressing power shortage are implemented.

Therefore, the present disclosure adopts the above-mentioned scheduling method, system, electronic device, and medium for addressing power shortage. The beneficial technical effect is that the present disclosure classifies demand-side flexible resources according to their characteristics, and constructs, based on the classification results, a dispatching mechanism for demand-side resources participating in actual scheduling. The dispatching mechanism can accept different types of adjustment resources to participate in optimization scheduling, and the dispatching mechanism can better fit the characteristics of resources. Compared with existing economic optimization scheduling methods that consider demand-side adjustability, the dispatching mechanism balances the cost of purchasing electricity from outside the province and dispatching on resources within the province, and considers the uncertainty of adjustability of distributed resources such as air conditioning and residential water heaters, making the constructed model more accurate and practical.

### BRIEF DESCRIPTION OF THE DRAWINGS

FIG. 1 is a flowchart of a scheduling method for addressing power shortage according to the present disclosure.

FIG. 2 shows the clearing framework diagram of demand-side resources participating in the rotating reserve market.

FIGS. 3a-3d show the costs of optimizing and scheduling various resources; where FIG. 3A shows the total cost of scheduling; FIG. 3B shows the cost of purchasing electricity from other power grids; FIG. 3C shows the cost of purchasing electricity from Class I load; and FIG. 3D shows the cost of purchasing electricity from Class II load.

### DETAILED DESCRIPTION OF THE EMBODIMENTS

The following provides further explanation of the technical solution of the present disclosure through the accompanying drawings and embodiments.

Unless otherwise defined, the technical or scientific terms used in the present disclosure shall have the usual meanings as understood by those skilled in the art to which the present disclosure belongs.

### Embodiment 1

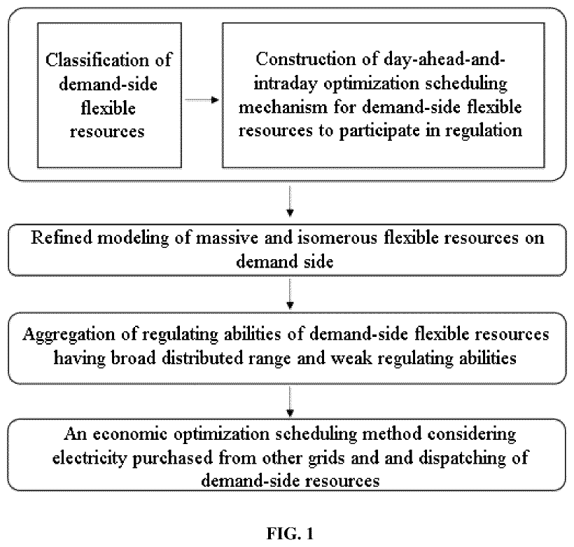

As shown in FIG. 1, it is a flowchart of a scheduling method for addressing power shortage in accordance with the present disclosure, including following steps S1 to S5.

In step S1, demand-side flexible resources are classified. The demand-side flexible resources includes industrial load, residential load, and commercial load. And the industrial load is Class I load, and the residential road and commercial load are Class II load.

Specifically, demand-side flexibility resources have a wide distribution range and rich types, mainly including industrial loads, residential loads, industrial and commercial loads, and agricultural loads. The agricultural loads mainly depend on the demand for agricultural production, with weak regulating capacity. Therefore, the demand-side response mainly considers the industrial loads, the residential loads, and the industrial and commercial loads.

The industrial loads are relatively concentrated in the power grid, with large individual regulating capabilities and easy centralized management. These types of loads are referred to as Class I load. This type of load can participate in demand response in the form of individuals. The characteristics of the residential loads, industrial and commercial loads include wide distribution range, large base, weak individual regulating capabilities, and diversified participation willingness. These types of loads are referred to as Class II loads. Therefore, when participating in demand response, the Class II load needs to first aggregate regulating capabilities, and then participates in market scheduling in the form of aggregates.

For the Class II load, the available user response electricity is related to factors such as incentive prices and the environment. Under a certain weather condition σ and other environmental conditions γ (including policies, individual users, etc.), when the power grid operator provides a certain demand-response price scheme z, the flexible resource electricity P_{adj}, that can be mined from the demand side is expressed as:

$${P}_{adj} = f ( Z \vert γ , σ ) . \qquad ( 1 )$$

When there is a power shortage in the power system, the demand amount P_{adj0} for electricity of flexible resource can be determined. By performing an inverse transformation on the Formula (1), the price scheme Z₀ in the market can be determined:

$${Z}_{0} = {f}^{- 1} ( {P}_{adj 0} \vert γ , σ ) . \qquad ( 2 )$$

In step S2, according to a classification result of the demand-side flexible resources, a day-ahead-and-intraday optimization scheduling mechanism for demand-side resources to participate in system regulating can be constructed.

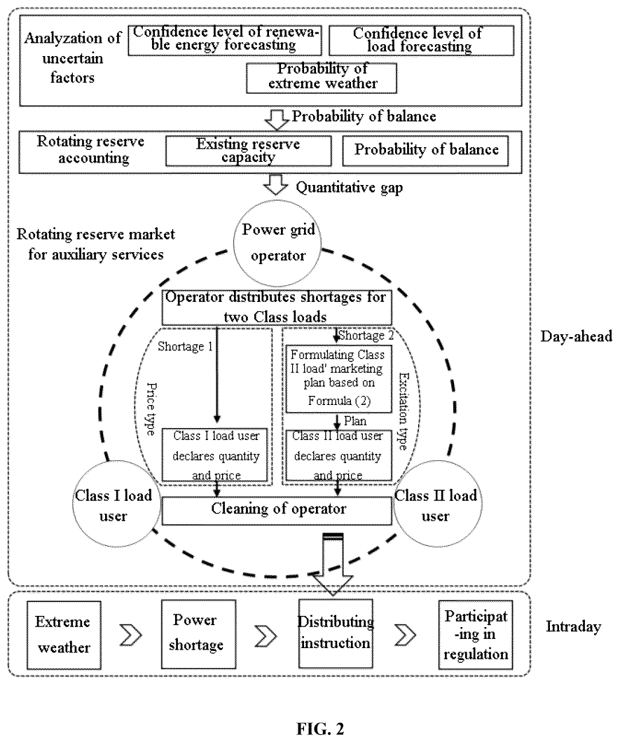

When there is a power shortage in the power system, it is difficult for the reserve capacity of the local power grid to provide sufficient support. In order to effectively utilize the flexibility of demand-side resources and increase reserve capacity to address supply guarantee issues. FIG. 2 provides a day-ahead-and-intraday optimization scheduling framework for demand-side resources participating in the rotating reserve.

In a day-ahead stage, the scheduling center infers a probability of source-load balance and a reserve capacity may be needed to be dispatched according to predicted results of renewable energy and load as well as a probability of different weather conditions. Then the scheduling center sends information of the predicted results and the reserve capacity to a marketing department, which splits a shortage into two parts as a basis for forecasting the Class I load and the Class II load, respectively. The scheduling center performs an optimized calculation according to a forecast of the Class I load and the Class II load, and distributes a calculation result to a user.

In an intraday stage, when user-side resources are needed to be dispatched, the user is notified according to the distributed calculation result to respond. When user-side resources are not needed to participate, the user is not notified.

In step S3, demand-side flexible resources are modeled.

The modeling demand-side flexible resources includes constructing a model of the Class I load and a model of the Class II load.

The proportion of industrial load in the electricity consumption structure is relatively large, and the demand for load electricity is relatively stable. Some industrial loads in industries such as chemical, railway, and mining do not have the regulating ability due to the particularity of the industry and the high requirements for stability and reliability of power supply. The adjustable range of loads such as steel processing, silicon carbide and cement production has relatively clear upper and lower limits, and has good regulating potential, with the ability to participate in demand response.

Due to characteristics of high energy consumption, this type of load will be equipped with reactive power compensation devices to avoid the assessment of power factor by power system operators. Therefore, when the power system is modeled, the impact of reactive power on the power system is not considered. The regulating capability of active power, regulating rate, and electricity demand are used to describe the regulating capability of Class I load. The constraints of the model of Class I load are as follows:
a power-balance constraint:

$${P}_{i , s , adj}^{t} = {P}_{i , s , base}^{t} - {P}_{i , s}^{t} ; \qquad ( 3 )$$

a power-regulating constraint:

$${P}_{i , s , adj}^{min} \leq {P}_{i , s , adj}^{t} \leq {P}_{i , s , adj}^{max} ; \qquad ( 4 )$$

an actual-demand-power constraint:

$${P}_{i , s}^{min} \leq {P}_{i , s}^{t} \leq {P}_{i , s}^{max} ; \qquad ( 5 )$$

a climbing constraint:

$${r}_{i , s}^{min} \leq {P}_{i , s}^{t} - {P}_{i , s}^{t - 1} \leq {r}_{i , s}^{max} ; \qquad ( 6 )$$

and
an energy-consumption constraint:

$${E}_{i , s}^{min} \leq {\sum }_{k = 1}^{N} {P}_{i , s}^{{t}_{k}} \cdot ( {t}_{k} - {t}_{k - 1} ) \leq {E}_{i , s}^{max} ; \qquad ( 7 )$$

where

$${P}_{i , s , adj}^{t}$$

represents a regulating power of Class I load s on node i participating in demand response at moment t;

$${P}_{i , s , base}^{t}$$

represents a required power of Class I load s on node i not participating in demand response at moment t;

$${P}_{i , s}^{t}$$

represents an actual required power of Class I load s on node i after participating in regulating at moment t;

$${P}_{i , s}^{t - 1}$$

represents an actual required power of Class I load s on node i after participating in regulating at moment t−1;

$${P}_{i , s , adj}^{max} and {P}_{i , s , adj}^{min}$$

represent an upper limit and a lower limit of a regulating power of Class I load s on node i participating in demand response, respectively;

$${P}_{i , s}^{max} and {P}_{i , s}^{min}$$

represent an upper limit and a lower limit of an actual required power of Class I load s on node i respectively, depending on a maximum transmission power of a circult;

$${r}_{i , s}^{max} and {r}_{i , s}^{min}$$

represent an upper limit and a lower limit of a regulating rate of Class I load s on node i, respectively;

$${E}_{i , s}^{max} and {E}_{i , s}^{min}$$

represent electric energy required for a production plan with a maximum load and electric energy required for a production plan with a minimum load during a period of t₀˜t_{N}, respectively, N represents a number of calculated moments; k represents a moment number; tₖ represents a k th moment; tₖ₋₁ represents a k−1 moment; s∈{Steel,SiC,Cement}, and where Steel represents a steel load, SiC represents a silicon-carbide industrial load, and Cement represents a cement processing load.

At the factory's online node, a Static Var Compensator (SVC) is installed accordingly, and model of the SVC is as follows:

$${Q}_{i , svc}^{min} \leq {Q}_{i , svc}^{t} \leq {Q}_{i , svc}^{max} ; \qquad ( 8 )$$

where

$${Q}_{i , svc}^{t}$$

represents the reactive power generated by SVC on node i at moment t and

$${Q}_{i , svc}^{max} and {Q}_{i , svc}^{min}$$

represent the upper limit and the lower limit of the reactive power generated by SVC, respectively.

The model of the Class II load includes a model of general resource, a model of air-conditioning load, and a model of residential water-heater load.

For the model of general resource, a probability of user in power system scheduling on node i under policy incentives is

$${p}_{i , h}^{t} ,$$

and a power of user participating in regulating of power system on node i at moment t is expressed as:

$${P}_{i , h , adj}^{t} = {p}_{i , h}^{t} \cdot Δ {P}_{i , h}^{t} ; \qquad ( 9 )$$

$${Q}_{i , h , adj}^{t} = {p}_{i , h}^{t} \cdot Δ {Q}_{i , h}^{t} ; \qquad ( 10 )$$

$$0 \leq {p}_{i , h}^{t} \leq 1 ; \qquad ( 11 )$$

where

$${P}_{i , h , adj}^{t} and {Q}_{i , h , adj}^{t}$$

represent an active power and a reactive power of Class II load h on node i actually participating in regulating at moment t, respectively; and

$$Δ {P}_{i , h}^{t} and Δ {Q}_{i , h}^{t}$$

represent a maximum active regulating power and a maximum reactive regulating power of Class II load h on node i that can participate in regulating at moment t, respectively.

The actual online load of user on node i includes:

$${P}_{i , h}^{t} = {P}_{i , h , base}^{t} - {P}_{i , h , adj}^{t} ; \qquad ( 12 )$$

$${Q}_{i , h}^{t} = {Q}_{i , h , base}^{t} - {Q}_{i , h , adj}^{t} ; \qquad ( 13 )$$

where

$${P}_{i , h , base}^{t} and {Q}_{i , h , base}^{t}$$

represent an active power demand and a reactive power demand of Class II load h on node i not participating in regulating at moment t, respectively; and

$${P}_{i , h}^{t} and {Q}_{i , h}^{t}$$

represent an active-power actual demand power and a reactive power actual demand power of Class II load h on node i after participating in regulating at moment t, respectively.

For the model of air-conditioning load, it is assumed that an indoor temperature of an air-conditioning user on node i completely participating in regulating at moment t is

$${T}_{i , in}^{t′} ,$$

then an adjustment amount of an indoor temperature of the air-conditioning user is represented by

$$Δ {T}_{i , in}^{t′} = {T}_{i , in}^{t′} - {T}_{i , in}^{t} ,$$

where

$${T}_{i , in}^{t}$$

represents an indoor temperature of an air-conditioning user on node i not participating in regulating at moment t, and where a relationship between a viriation in state of charge

$$Δ S O {C}_{i , h ( airc )}^{t′}$$

and a vibration in power consumption

$$Δ {P}_{i , h ( airc )}^{t′}$$

corresponding to the adjustment amount of the indoor temperature is expressed as:

$$\begin{matrix}Δ S O {C}_{i , h ( airc )}^{t′} = S O {C}_{i , h ( airc )}^{t′} - S O {C}_{i , h ( airc )}^{t} \\ = \frac{Δ {T}_{i , in}^{t′}}{{T}_{i , max} - {T}_{i , min}}\end{matrix} ; \qquad ( 14 )$$

$$\begin{matrix}Δ S O {C}_{i , h ( airc )}^{t + 1 ′} = S O {C}_{i , h ( airc )}^{t + 1 ′} - S O {C}_{i , h ( airc )}^{t + 1} \\ = {a}_{1} Δ S O {C}_{i , h ( airc )}^{t′} + {a}_{2} Δ {P}_{i , h ( airc )}^{t′} + {a}_{3} Δ {P}_{i , h ( airc )}^{t + 1 ′}\end{matrix} ; \qquad ( 15 )$$

where

$$S O {C}_{i , h ( airc )}^{t}$$

represents a state of charge of an air-conditioning user on node i not participating in regulating at moment t;

$$S O {C}_{i , h ( airc )}^{t ′}$$

represents a state of charge of air-conditioning user on node i completely participating in regulating at moment t; T_{i,max} and T_{i,min} represent a maximum adjustable temperature and a minimum adjustable temperature of an air conditioner on node i, respectively;

$$Δ {P}_{{i , h ( airc )}^{}}^{t ′}$$

represents a power variation of an air-conditioning load on node i participating in regulating at moment t; a₁, a₂ and a₃ all represent model parameters;

$$Δ S O {C}_{i , h ( airc )}^{t + 1 ′} , S O {C}_{i , h ( airc )}^{t + 1 ′} , S O {C}_{i , h ( airc )}^{t + 1} , and {P}_{i , h ( airc )}^{t + 1 ′}$$

represent a state of

$$Δ S O {C}_{i , h ( airc )}^{t + 1 ′}$$

at moment t+1, a state of

$$S O {C}_{i , h ( airc )}^{t ′}$$

at moment t+1, a state of

$$S O {C}_{i , h ( airc )}^{t}$$

at moment t+1, and a state of

$$Δ {P}_{i , h ( airc )}^{t ′}$$

at moment t+1, respectively.

It is considered that a probability of user participating in regulating is influenced by differences in psychology of participation of user individuals, when a participation probability of user

$${p}_{i , h ( airc )}^{t}$$

is introduced, an actual power consumption of the air-conditioning load

$${P}_{i , h ( airc )}^{t}$$

is represented by:

$${P}_{i , h ( airc )}^{t} = {P}_{base , i , h ( airc )}^{t} - {p}_{i , h ( airc )}^{t} \cdot Δ {P}_{i , h ( airc )}^{t ′} ; \qquad ( 16 )$$

where

$${P}_{base , i , h ( airc )}^{t}$$

represents a power required by the air-conditioning load on node i not participating in demand response at moment t.

For the model of the residential water-heater load, it is assumed that a heating upper-limit temperature of a water heater of a user having a residential water-heater load on node i completely participating in regulating at moment t is an upper-limit temperature of the water heater

$${T}_{i , h ( rwh )}^{max} ,$$

then an adjustment amount of temperature of the residential water-hearter load on node i participating in regulating at moment t is represented by

$$Δ {T}_{i , h ( rwh )}^{t ′} = {T}_{i , h ( rwh )}^{max} - {T}_{i , h ( rwh )}^{t} ;$$

where

$${T}_{i , h ( rwh )}^{t}$$

represents an upper-limit temperature set by the water heater when the user having residential water-heater load on node i not participating in regulating at moment t, and where a relationship between a vibration in state of charge

$$Δ S O {C}_{i , h ( rwh )}^{t ′}$$

and a vibration in power consumption

$$Δ {P}_{i , h ( rwh )}^{t ′}$$

corresponding to the adjustment amount of the residential water-heater temperature is expressed as:

$$\begin{matrix}Δ {SOC}_{i , h ( rwh )}^{t ′} = {SOC}_{i , h ( rwh )}^{t ′} - {SOC}_{i , h ( rwh )}^{t} \\ = 1 - \frac{{T}_{i , h ( rwh )}^{t}}{{T}_{i , h ( rwh )}^{max}} ;\end{matrix} \qquad ( 17 )$$

$$\begin{matrix}{SOC}_{i , h ( rwh )}^{t + 1 ′} = {SOC}_{i , h ( rwh )}^{t + 1 ′} - {SOC}_{i , h ( rwh )}^{t + 1} \\ = {a}_{t} Δ {SOC}_{i , h ( rwh )}^{t ′} - \frac{{b}_{t}}{{T}_{i , h ( rwh )}^{max}} Δ {P}_{i , h ( rwh )}^{t ′} ;\end{matrix} \qquad ( 18 )$$

where

$${SOC}_{i , h ( rwh )}^{t}$$

represents a state of charge of a water heater corresponding to

$${T}_{i , h ( rwh )}^{t}$$

when the residential water-heater load on node i does not participates in regulating at moment t;

$${SOC}_{i , h ( rwh )}^{t ′}$$

represents a state of charge of the water heater corresponding to

$${T}_{i , h ( rwh )}^{max}$$

when the residential water-heater load on node i completely participates in regulating at moment t; aₜ and bₜ represent unit parameters of a water-heater modular unit, respectively; and

$${SOC}_{i , h ( rwh )}^{t + 1 ′} , {SOC}_{i , h ( rwh )}^{t + 1 ′} , and {SOC}_{i , h ( rwh )}^{t + 1}$$

represent a state of

$${SOC}_{i , h ( rwh )}^{t ′}$$

at moment t+1, a state of

$${SOC}_{i , h ( rwh )}^{t ′}$$

at moment t+1, and a state of

$${SOC}_{i , h ( rwh )}^{t}$$

at moment t+1, respectively.

In step S4, regulating abilities of the Class II load are aggregated.

Specifically, Class II loads have multiple types, quantities, and wide distribution ranges, with limited ability to regulate a single resource. When participating in demand response, the Class II loads need to participate in power system scheduling through resource aggregation. The space formed by the power regulating range of Class II load aggregates is R²ⁿ, where n is the number of flexible resources. The willingness of users to participate

$${p}_{i , h}^{t}$$

does not affect the linear nature of resources. Therefore, within the aggregation range, all resource constraints and network constraints are linear constraints, manifested as high-dimensional convex polyhedron in space R²ⁿ. The projection of this convex polyhedron on the connection circuit between the aggregate and the power grid is a finite-sided convex polygon in space R², and the set of points that form this convex polygon is denoted as

$${Ω}_{pcc}^{t} .$$

Then a projection is solved by using a vertex search method, and the projection is a feasible region of a convex polygon.

By changing optimization directions of an objective function, optimization problems under different objective functions can be solved, and the extrapolation is gradually performed to obtain a boundary of the convex polygon. An objective function for solving the projection is expressed as:

$$max \{ μ {x}_{p c c}^{t} , {x}_{p c c}^{t} ∈ {Ω}_{p c c}^{t} \} ; \qquad ( 19 )$$

where μ=(μ_{P}, μ_{Q}) represents a direction vector in space R² and is determined by a normal vector of a boundary of an initial convex polygon;

$${x}_{p c c}^{t} = {( {P}_{p c c} , {Q}_{p c c} )}^{T}$$

represents a point within a feasible region

$${Ω}_{p c c}^{t} ;$$

P_{pcc} and Q_{pcc} represent a projected active power and a projected reactive power on a connection circuit between an aggregrate and a power grid, respectively.

The constraints for solving the projection includes constraints of adjustable output force constraints and power flow constraints of a connected network of each flexible resource.

And an optimization problem is solved, and a new vertex is searched for along a direction of a normal vector of each edge of the initial convex polygon. When a distance lₖ between the new vertex and an original edge is less than a constant value l_{δ}, a process of the solving is ended, and a condition of ending is expressed as:

$${l}_{k} = \frac{\vert M \cdot {P}_{pcc 0} + N \cdot {Q}_{pcc 0} + C \vert}{\sqrt{{M}^{2} + {N}^{2}}} \leq {l}_{δ} ; \qquad ( 20 )$$

where

$${x}_{pcc 0}^{t} = ( {P}_{pcc 0} , {Q}_{pcc 0} )$$

represents a coordinate of the new vertex; parameters M, N, and C are determined by a primary-side equation M·P+N·Q_{pcc0}+C=0; and P_{pcc0} and Q_{pcc0} represent newly solved projected active power and newly solved projected reactive power on the connection circuit between the aggregate and the power grid, respectively.

In step S5, an intraday optimization scheduling model is constructed based on a total cost of purchasing electricity from other power grids and a total cost of dispatching load-side resources.

When there is an electricity shortage in the system due to inaccurate weather forecasts, the optimization problem can be solved to optimize the quota for purchasing electricity from other places and the resource response quota on the load side, ensuring the balance of source-load electricity while achieving optimal economic efficiency. The intraday optimization scheduling model is as follows:

$$min {C}^{t} = {C}_{G}^{t} + {C}_{L}^{t} ; \qquad ( 21 )$$

$${C}_{G}^{t} = {\sum }_{{j}_{1}} {c}_{{j}_{1} , g}^{t} {P}_{{j}_{1} , g , adj}^{t} ; \qquad ( 22 )$$

$${C}_{L}^{t} = {C}_{L 1}^{t} + {C}_{L 2}^{t} = {\sum }_{{j}_{2}} {c}_{{j}_{2} , L 1}^{t} {P}_{{j}_{2} , L 1 , adj}^{t} + {\sum }_{{j}_{3}} {c}_{{j}_{3} , L 2}^{t} {P}_{{j}_{3} , L 2 , adj}^{t} ; \qquad ( 23 )$$

$${P}_{lack} = {\sum }_{{j}_{1}} {P}_{{j}_{1} , g , adj}^{t} + {\sum }_{{j}_{2}} {P}_{{j}_{2} , L 1 , adj}^{t} + {\sum }_{{j}_{3}} {P}_{{j}_{2} , L 2 , adj}^{t} ; \qquad ( 24 )$$

$$- {P}_{{j}_{1} , g , adj}^{max} \leq {P}_{{j}_{1} , g , adj}^{t} \leq {P}_{{j}_{1} , g , adj}^{max} ; \qquad ( 25 )$$

$${P}_{{j}_{2} , L 1 , adj}^{min} \leq {P}_{{j}_{2} , L 1 , adj}^{t} \leq {P}_{{j}_{2} , L 1 , adj}^{max} ; \qquad ( 26 )$$

$${P}_{{j}_{3} , L 2 , adj}^{min} \leq {P}_{{j}_{3} , L 2 , adj}^{t} \leq {P}_{{j}_{3} , L 2 , adj}^{max} ; \qquad ( 27 )$$

$${P}_{lack} \leq {\sum }_{{j}_{1}} {P}_{{j}_{1} , g , adj}^{max} + {\sum }_{{j}_{2}} {P}_{{j}_{2} , L 1 , adj}^{max} + {\sum }_{{j}_{3}} {P}_{{j}_{3} , L 2 , adj}^{max} ; \qquad ( 28 )$$

$$\{ \begin{matrix}{P}_{j} & = {\sum }_{i ∈ {φ}_{j 1}} ( {P}_{ij} - {r}_{ij} {l}_{ij} ) - {\sum }_{k ∈ {φ}_{j 2}} {P}_{jk} \\ {Q}_{j} & = {\sum }_{i ∈ {φ}_{j 1}} ( {Q}_{ij} - {x}_{ij} {l}_{ij} ) - {\sum }_{k ∈ {φ}_{j 2}} {Q}_{jk} \\ {V}_{j}^{2} & = {V}_{i}^{2} - 2 ( {r}_{ij} {P}_{ij} + {x}_{ij} {Q}_{ij} ) + ( {r}_{ij}^{2} + {x}_{ij}^{2} ) {I}_{ij}^{2} \\ {‖ \begin{matrix}2 {P}_{ij} \\ 2 {Q}_{ij} \\ {I}_{ij}^{2} - {V}_{i}^{2}\end{matrix} ‖}_{2} & \leq {I}_{ij}^{2} + {V}_{i}^{2} \\ {V}_{min} & \leq {V}_{i} \leq {V}_{max} \\ {I}_{min} & \leq {I}_{ij} \leq {I}_{max}\end{matrix} ; \qquad ( 29 )$$

where C^{t} represents a total cost at moment t;

$${C}_{G}^{t}$$

represents a total cost of purchasing electricity from other power grids;

$${C}_{L}^{t}$$

represents a total cost of dispatching load-side resources; j₁, j₂, and j₃ represent sets of nodes connected to other power grids, Class I load, and Class II load, respectively;

$${c}_{{j}_{1} , g}^{t} , {c}_{{j}_{2} , L 1}^{t} , and {c}_{{j}_{3} , L 2}^{t}$$

represent price of electricity purchased from other power grids, Class I load, and Class II load, respectively;

$${P}_{{j}_{1} , g , adj}^{t} , {P}_{{j}_{2} , L 1 , adj}^{t} , and {P}_{{j}_{3} , L 2 , adj}^{t}$$

represent electricities purchased from other power grids, Class I load, and Class II load, respectively; P_{lack} represents a power shortage in a system;

$${P}_{{j}_{1} , g , adj}^{max} , {P}_{{j}_{2} , L 1 , adj}^{max} , and {P}_{{j}_{3} , L 2 , adj}^{max}$$

represent upper limits of regulating capacity for other power grids, Class I load, and Class II load, respectively;

$${P}_{{j}_{2} , L 1 , adj}^{min} and {P}_{{j}_{3} , L 2 , adj}^{min}$$

represent lower limits of regulating capacity for Class I load and Class II load, respectively; Pⱼ and Qⱼ represent an active power and a reactive power injected into a node j, respectively; Pᵢⱼ and Qᵢⱼ represent an active power and a reactive power injected into a circult ij, respectively; rᵢⱼ, xᵢⱼ, and Iᵢⱼ represent a resistance per unit, a reactance per unit, and a length of circult ij, respectively; Vᵢ, Vₘₐₓ, and Vₘᵢₙ represent a voltage, a maximum voltage, and a minimum voltage of node i, respectively; Iᵢⱼ, Iₘₐₓ and Iₘᵢₙ represent a carrying current, a maximum carrying current, and a minimum carrying current of circuit ij, respectively; φⱼ₁ represents a set of upstream nodes of node j; and φⱼ₂ represents a set of downstream nodes of node i.

The present disclosure will be further explained through specific experiments.

The IEEE-33 node system is selected as the simulation topolooy structure, with cardinalities of 50 Chinese yuan/MW, 30 Chinese yuan/MW, and 35 Chinese yuan/MW for

$${c}_{{j}_{1} , g}^{t} , {c}_{{j}_{2} , L 1}^{t} , and {c}_{{j}_{3} , L 2}^{t} ,$$

respectively, and random numbers are generated within the upper and lower 50% intervals based on Gaussian distribution as the values of

$${c}_{{j}_{1} , g}^{t} , {c}_{{j}_{2} , L 1}^{t} and {c}_{{j}_{3} , L 2}^{t}$$

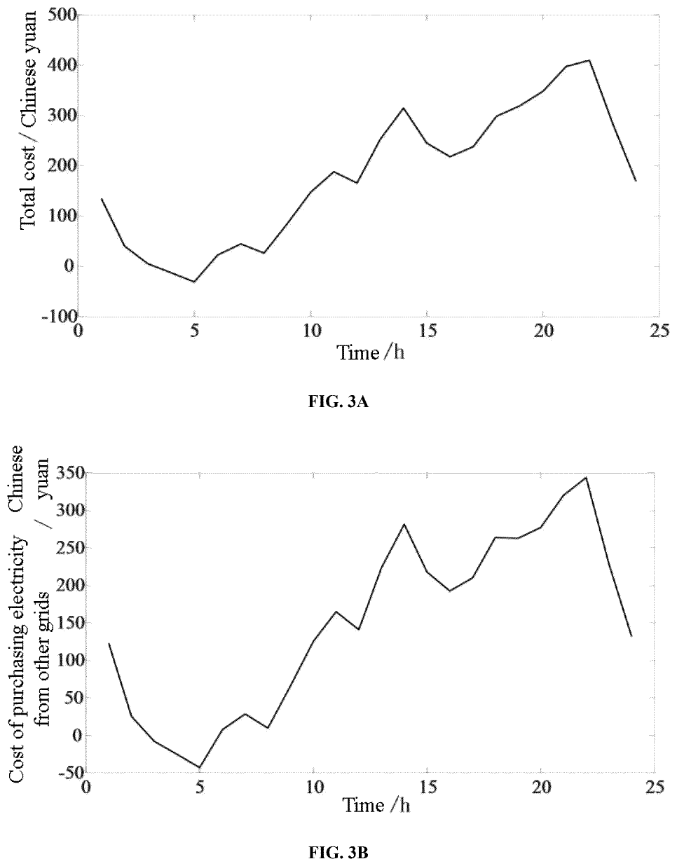

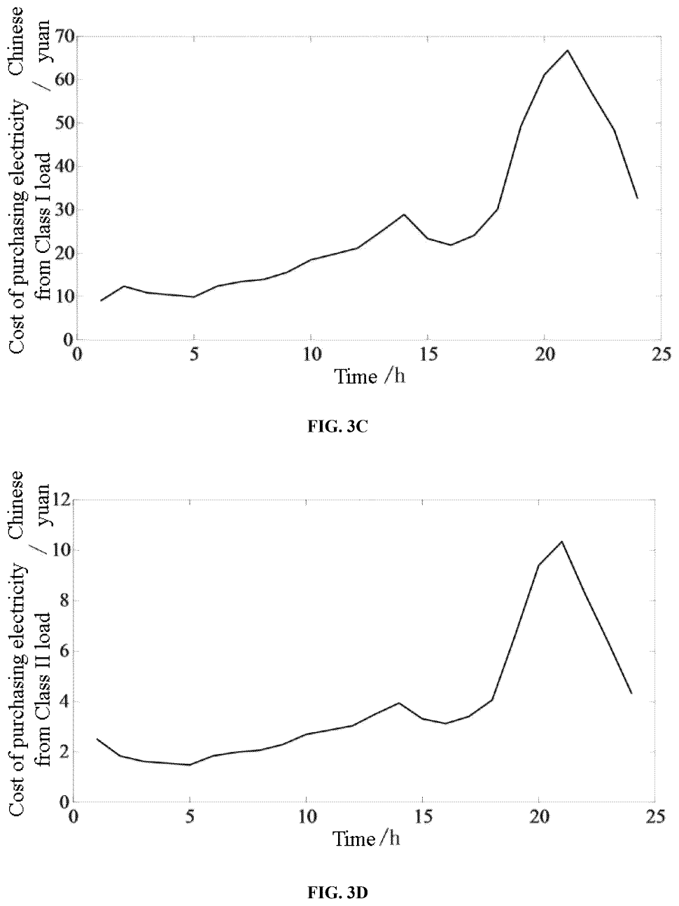

at each moment. Based on the proposed optimization method, the economic optimization scheduling results shown in FIGS. 3A-3D can be obtained. Where FIG. 3A shows the total cost after optimization, while FIGS. 3B-3D represent the costs of electricity purchased from other power grids, Class I load, and Class II load, respectively. From the optimization results, it can be seen that when there is an intraday power shortage, the participation of demand-side flexibility resources can effectively reduce the amount of electricity purchased from other power grids, and can effectively reduce the cost of making up for the power shortage.

### Embodiment 2

The present disclosure also provides a scheduling system for addressing power shortage, including:
a resource classification module, configured for classifying demand-side flexible resources, where the the demand-side flexible resources includes Class I load and Class II load;
a scheduling-mechanism construction module, configured for constructing a day-ahead-and-intraday optimization scheduling mechanism for demand-side resources to participate in system regulating according to a classification result of demand-side flexible resources;
a resource modeling module, configured for modeling demand-side flexible resources, where the modeling includes constructing a model of the Class I load and a model of the Class II load;
an adjustment capability aggregation module, configured for aggregating regulating abilities of the Class II load; and
an intraday optimization scheduling model module, configured for constructing an intraday optimization scheduling model based on a total cost of purchasing electricity from other power grids and a total cost of dispatching load-side resources.

If the aforementioned functions are implemented in the form of software functional units and sold or used as independent products, they can be stored in a computer-readable storage medium. Based on this understanding, the technical solution of the present disclosure, a part contributing to the existing technology, or a part of the technical solution can essentially be reflected in the form of a software product. The computer software product is stored in a storage medium and includes several instructions to enable a computer device (which can be a personal computer, server, or network device, etc.) to perform all or part of the steps of the methods described in various embodiments of the present disclosure. The aforementioned storage medium include: USB flash drives, portable hard drives, read-only memory (ROM), random access memory (RAM), magnetic disks or optical disks, and various other medium that can store program code.

The logic and/or steps represented in a flowchart or otherwise described herein, such as a sequential list of executable instructions used to implement logical functions, can be specifically implemented in any computer-readable medium for use by instruction execution systems, devices, or equipments (such as computer-based systems, systems including processors, or other systems that can take instructions from instruction execution systems, devices, or equipments and execute instructions), or used in conjunction with these instruction execution systems, devices, or equipments. For the purpose of this specification, “computer-readable medium” may be any device that can contain, store, communicate, disseminate, or transmit programs for use in instruction execution systems, devices, or equipments, or in combination with such instruction execution systems, devices, or equipments.

More specific examples of computer-readable medium (non exhaustive list) include electrical connectors (electronic devices) with one or more wiring, portable computer enclosures (magnetic devices), random access memory (RAM), read-only memory (ROM), erasable and editable read-only memory (EPROM or flash memory), fiber optic devices, and portable optical disc read-only memory (CDROM). In addition, computer-readable medium can even be paper or other suitable medium on which the program can be printed, as the program can be obtained electronically, for example, by optical scanning of paper or other medium, followed by editing, interpretation, or necessary processing in other suitable ways, and then stored in computer memory.

It is worth noting that the contents not elaborated in detail in the present disclosure are all prior art and are well-known to those skilled in the art.

Therefore, the present disclosure adopts the aforementioned scheduling method, system, electronic device, and medium for addressing power shortage. By classifying demand-side resources and constructing an optimization scheduling mechanism, different types of regulating resources are effectively dispatched to participate in optimization scheduling, balancing the cost of electricity purchased from outside the province and the cost of resources dispatched within the province. By considering the uncertainty of the adjustable capacities of distributed resources, the model is made more accurate and practical, thereby reducing the cost of scheduling during power shortages.

Finally, it should be noted that the above embodiments are only used to illustrate the technical solution of the present disclosure and not to limit it. Although the present disclosure has been described in detail with reference to the preferred embodiments, those skilled in the art should understand that modifications or equivalent substitutions can still be made to the technical solution of the present disclosure, and these modifications or equivalent substitutions cannot make the modified technical solution deviate from the spirit and scope of the technical solution of the present disclosure.

What is claimed is:

1. A scheduling method for addressing power shortages, comprising the following steps:
step S1: classifying demand-side flexible resources, wherein the demand-side flexible resources comprise industrial load, residential load, and commercial load, and wherein, the industrial load is Class I load, the residential load and the commercial load are Class II loads;
step S2: according to a classification result of the demand-side flexible resources, constructing a day-ahead-and-intraday optimization scheduling mechanism for demand-side resources to participate in system regulating;
step S3: modeling demand-side flexible resources;
step S4: aggregating regulating abilities of the Class II load; and
step S5: constructing an intraday optimization scheduling model based on a total cost of purchasing electricity from other power grids and a total cost of dispatching load-side resources;
wherein the day-ahead-and-intraday optimization scheduling mechanism for demand-side resources to participate in system regulating comprises:
in a day-ahead stage, a probability of source-load balance and a reserve capacity may be needed to be dispatched are inferred by a scheduling center according to predicted results of renewable energy and load, combined with a probability of different weather conditions; wherein information of the predicted results and the reserve capacity is sent to a marketing department, which splits a shortage into two parts as a basis for forecasting the Class I load and the Class II load, respectively; an optimized calculation is performed by the scheduling center according to a forecast of the Class I load and the Class II load, and a calculation result is distributed to a user;
in an intraday stage, when user-side resources are needed to be dispatched, the user is notified according to the distributed calculation result to respond; when user-side resources are not needed to participate, the user is not notified;
and wherein, in step S5, the intraday optimization scheduling model comprises:
$$min {C}^{t} = {C}_{G}^{t} + {C}_{L}^{t} ;$$
$${C}_{G}^{t} = {\sum }_{{j}_{1}} {c}_{{j}_{1} , g}^{t} {P}_{{j}_{1} , g , adj}^{t} ;$$
$${C}_{L}^{t} = {C}_{L 1}^{t} + {C}_{L 2}^{t} = {\sum }_{{j}_{2}} {c}_{{j}_{2} , L 1}^{t} {P}_{{j}_{2} , L 1 , adj}^{t} + {\sum }_{{j}_{3}} {c}_{{j}_{3} , L 2}^{t} {P}_{{j}_{3} , L 2 , adj}^{t} ;$$
$${P}_{lack} = {\sum }_{{j}_{1}} {P}_{{j}_{1} , g , adj}^{t} + {\sum }_{{j}_{2}} {P}_{{j}_{2} , L 1 , adj}^{t} + {\sum }_{{j}_{3}} {P}_{{j}_{2} , L 2 , adj}^{t} ;$$
$$- {P}_{{j}_{1} , g , adj}^{max} \leq {P}_{{j}_{1} , g , adj}^{t} \leq {P}_{{j}_{1} , g , adj}^{max} ;$$
$${P}_{{j}_{2} , L 1 , adj}^{min} \leq {P}_{{j}_{2} , L 1 , adj}^{t} \leq {P}_{{j}_{2} , L 1 , adj}^{max} ;$$
$${P}_{{j}_{3} , L 2 , adj}^{min} \leq {P}_{{j}_{3} , L 2 , adj}^{t} \leq {P}_{{j}_{3} , L 2 , adj}^{max} ;$$
$${P}_{lack} \leq {\sum }_{{j}_{1}} {P}_{{j}_{1} , g , adj}^{max} + {\sum }_{{j}_{2}} {P}_{{j}_{2} , L 1 , adj}^{max} + {\sum }_{{j}_{3}} {P}_{{j}_{3} , L 2 , adj}^{max} ;$$
$$\{ \begin{matrix}{P}_{j} & = {\sum }_{i ∈ {φ}_{j 1}} ( {P}_{ij} - {r}_{ij} {l}_{ij} ) - {\sum }_{k ∈ {φ}_{j 2}} {P}_{jk} \\ {Q}_{j} & = {\sum }_{i ∈ {φ}_{j 1}} ( {Q}_{ij} - {x}_{ij} {l}_{ij} ) - {\sum }_{k ∈ {φ}_{j 2}} {Q}_{jk} \\ {V}_{j}^{2} & = {V}_{i}^{2} - 2 ( {r}_{ij} {P}_{ij} + {x}_{ij} {Q}_{ij} ) + ( {r}_{ij}^{2} + {x}_{ij}^{2} ) {I}_{ij}^{2} \\ {‖ \begin{matrix}2 {P}_{ij} \\ 2 {Q}_{ij} \\ {I}_{ij}^{2} - {V}_{i}^{2}\end{matrix} ‖}_{2} & \leq {I}_{ij}^{2} + {V}_{i}^{2} \\ {V}_{min} & \leq {V}_{i} \leq {V}_{max} \\ {I}_{min} & \leq {I}_{ij} \leq {I}_{max}\end{matrix} ;$$
wherein C^{t} represents a total cost at moment t;
$${C}_{G}^{t}$$
represents a total cost of purchasing electricity from other power grids;
$${C}_{L}^{t}$$
represents a total cost of dispatching load-side resources; j₁, j₂, and j₃ represent sets of nodes connected to other power grids, Class I load, and Class II load, respectively;
$${c}_{{j}_{1} , g}^{t} , {c}_{{j}_{2} , L 1}^{t} , and {c}_{{j}_{3} , L 2}^{t}$$
represent price of electricity purchased from other power grids, Class I load, and Class II load, respectively;
$${P}_{{j}_{1} , g , adj}^{t} , {P}_{{j}_{2} , L 1 , adj}^{t} , and {P}_{{j}_{3} , L 2 , adj}^{t}$$
represent amount of electricity purchased from other power grids, Class I load, and Class II load, respectively; P_{lack} represents a power shortage in a system;
$${P}_{{j}_{1} , g , adj}^{max} , {P}_{{j}_{2} , L 1 , adj}^{max} , and {P}_{{j}_{3} , L 2 , adj}^{max}$$
represent upper limits of regulating capacity for other power grids, Class I load, and Class II load, respectively;
$${P}_{{j}_{2} , L 1 , adj}^{min} and {P}_{{j}_{3} , L 2 , adj}^{min}$$
represent lower limits of regulating capacity for Class I load and Class II load, respectively; Pⱼ and Qⱼ represent an active power and a reactive power injected into a node j, respectively; Pᵢⱼ and Qᵢⱼ represent an active power and a reactive power injected into a circuit i, respectively; rᵢⱼ, xᵢⱼ, and lᵢⱼ represent a resistance per unit, a reactance per unit, and a length of circuit ij, respectively; Vᵢ, Vₘₐₓ, and Vₘᵢₙ represent a voltage, a maximum voltage, and a minimum voltage of node i, respectively; Iᵢⱼ, Iₘₐₓ, and Iₘᵢₙ represent a maximum carrying current, and a minimum carrying current of circuit ij, respectively; φⱼ₁ represents a set of upstream nodes of node j; and φⱼ₂ represents a set of downstream nodes of node j.

2. The scheduling method for addressing power shortages according to claim 1, wherein in step S3, the modeling demand-side flexible resources comprises constructing a model of the Class I load and a model of the Class II load;
wherein constraints of the model of the Class I load comprise:
a power-balance constraint:
$${P}_{i , s , adj}^{t} = {P}_{i , s , base}^{t} - {P}_{i , s}^{t} ;$$
a power-regulating constraint:
$${P}_{i , s , adj}^{min} \leq {P}_{i , s , adj}^{t} \leq {P}_{i , s , adj}^{max} ;$$
an actual-demand-power constraint:
$${P}_{i , s}^{min} \leq {P}_{i , s}^{t} \leq {P}_{i , s}^{max} ;$$
a climbing constraint:
$${r}_{i , s}^{min} \leq {P}_{i , s}^{t} - {P}_{i , s}^{t - 1} \leq {r}_{i , s}^{max} ;$$
and
an energy-consumption constraint:
$${E}_{i , s}^{min} \leq {\sum }_{k = 1}^{N} {P}_{i , s}^{{t}_{k}} \cdot ( {t}_{k} - {t}_{k - 1} ) \leq {E}_{i , s}^{max} ;$$
wherein
$${P}_{i , s , adj}^{t}$$
represents a regulating power of Class I load s on node i participating in demand response at moment t;
$${P}_{i , s , base}^{t}$$
represents a required power of Class I load s on node i not participating in demand response at moment t;
$${P}_{i , s}^{t}$$
represents an actual required power of Class I load s on node i after participating in regulating at moment t;
$${P}_{i , s}^{t - 1}$$
represents an actual required power of Class I load s on node i after participating in regulating at moment t−1;
$${P}_{i , s , adj}^{max} and {P}_{i , s , adj}^{min}$$
represent an upper limit and a lower limit of a regulating power of Class I load s on node i participating in demand response, respectively;
$${P}_{i , s}^{max} and {P}_{i , s}^{min}$$
represent an upper limit and a lower limit of an actual required power of Class I load s on node i respectively, depending on a maximum transmission power of a circuit;
$${r}_{i , s}^{max} and {r}_{i , s}^{min}$$
represent an upper limit and a lower limit of a regulating rate of Class I load s on node i, respectively;
$${E}_{i , s}^{max} and {E}_{i , s}^{min}$$
represent electric energy required for a production plan with a maximum load and electric energy required for a production plan with a minimum load during a period of t₀˜t_{N}, respectively; N represents a number of calculated moments; k represents a moment number; tₖ represents a k th moment; tₖ₋₁ represents a k−1 moment; s∈{Steel,SiC,Cement}, and where Steel represents a steel load, SiC represents a silicon-carbide industrial load, and Cement represents a cement processing load;
wherein the model of the Class II load comprises a model of general resource, a model of air-conditioning load, and a model of residential water-heater load;
wherein for the model of general resource, a probability of user participating in power system scheduling on node i under policy incentives is
$${p}_{i , h}^{t} ,$$
and a power of user participating in regulating of power system on node i at moment t is expressed as:
$${P}_{i , h , adj}^{t} = {p}_{i , h}^{t} \cdot Δ {P}_{i , h}^{t} ; \\ {Q}_{i , h , adj}^{t} = {p}_{i , h}^{t} \cdot Δ {Q}_{i , h}^{t} ; \\ 0 \leq {p}_{i , h}^{t} \leq 1 ;$$
wherein
$${P}_{i , h , adj}^{t} and {Q}_{i , h , adj}^{t}$$
represent an active power and a reactive power of Class II load h on node i actually participating in regulating at moment t, respectively; and
$$Δ {P}_{i , h}^{t} and Δ {Q}_{i , h}^{t}$$
represent a maximum active regulating power and a maximum reactive regulating power of Class II load h on node i that can participate in regulating at moment t, respectively;
wherein an actual online load of user on node i comprises:
$${P}_{i , h}^{t} = {P}_{i , h , base}^{t} - {P}_{i , h , adj}^{t} ; \\ {Q}_{i , h}^{t} = {Q}_{i , h , base}^{t} - {Q}_{i , h , adj}^{t} ;$$
wherein
$${P}_{i , h , base}^{t} and {Q}_{i , h , base}^{t}$$
represent an active power demand and a reactive power demand of Class II load h on node i not participating in regulating at moment t, respectively; and
$${P}_{i , h}^{t} and {Q}_{i , h}^{t}$$
represent an active-power actual demand power and a reactive-power actual demand power of Class II load h on node i after participating in regulating at moment t, respectively;
wherein, for the model of air-conditioning load, it is assumed that an indoor temperature of an air-conditioning user on node i completely participating in regulating at moment t is
$${T}_{i , in}^{t ′} ,$$
and an adjustment amount of an indoor temperature of the air-conditioning user is represented by
$$Δ {T}_{i , in}^{t ′} = {T}_{i , in}^{t ′} - {T}_{i , in}^{t} ,$$
wherein
$${T}_{i , in}^{t}$$
represents an indoor temperature of an air-conditioning user on node i not participating in regulating at moment t, and wherein a relationship between a vibration in state of charge
$$Δ {SOC}_{i , h ( airc )}^{t ′}$$
and a vibration in power consumption
$$Δ {P}_{i , h ( airc )}^{t ′}$$
corresponding to the adjustment amount of the indoor temperature is expressed as:
$$Δ {SOC}_{i , h ( airc )}^{t ′} = {SOC}_{i , h ( airc )}^{t ′} - {SOC}_{i , h ( airc )}^{t} = \frac{Δ {T}_{i , in}^{t ′}}{{T}_{i , max} - {T}_{i , min}} ; \\ Δ {SOC}_{i , h ( airc )}^{t + 1 ′} = {SOC}_{i , h ( airc )}^{t + 1 ′} - {SOC}_{i , h ( airc )}^{t + 1} = {a}_{1} Δ {SOC}_{i , h ( airc )}^{t ′} + {a}_{2} Δ {P}_{i , h ( airc )}^{t ′} + {a}_{3} Δ {P}_{i , h ( airc )}^{t + 1 ′} ;$$
wherein
$${SOC}_{i , h ( airc )}^{t}$$
represents a state of charge of an air-conditioning user on node i not participating in regulating at moment t;
$${SOC}_{i , h ( airc )}^{t ′}$$
represents a state of charge of air-conditioning user on node i completely participating in regulating at moment t; T_{i,max} and T_{i,min} represent a maximum adjustable temperature and a minimum adjustable temperature of an air conditioner on node i, respectively;
$$Δ {P}_{i , h ( airc )}^{t ′}$$
represents a power variation of an air-conditioning load on node i participating in regulating at moment t; a₁, a₂ and a₃ all represent model parameters;
$${SOC}_{i , h ( airc )}^{t + 1 ′} , {SOC}_{i , h ( airc )}^{t + 1 ′} , {SOC}_{i , h ( airc )}^{t + 1} , and Δ {P}_{i , h ( airc )}^{t + 1 ′}$$
represent a state of
$$Δ {SOC}_{i , h ( airc )}^{t ′}$$
at moment t+1, a state of
$${SOC}_{i , h ( airc )}^{t ′}$$
at moment t+1, a state of
$${SOC}_{i , h ( airc )}^{t}$$
at moment t+1, and a state of
$$Δ {P}_{i , h ( airc )}^{t ′}$$
at moment t+1, respectively;
wherein it is considered that a probability of user participating in regulating is influenced by differences in psychology of participation of user individuals, when a participation probability of user
$${p}_{i , h ( arc )}^{t}$$
is introduced, an actual power consumption of the air-conditioning load
$${P}_{ι , h ( airc )}^{t}$$
is represented by:
$${P}_{i , h ( airc )}^{t} = {P}_{base , i , h ( airc )}^{t} - {p}_{i , h ( arc )}^{t} \cdot Δ {P}_{i , h ( airc )}^{t ′} ;$$
wherein
$${P}_{base , i , h ( airc )}^{t}$$
represents a power required by the air-conditioning load on node i not participating in demand response at moment t;
for the model of the residential water-heater load, it is assumed that a heating upper-limit temperature of a water heater of a user having a residential water-heater load on node i completely participating in regulating at moment t is an upper-limit temperature of the water heater
$${T}_{i , h ( rwh )}^{max} ,$$
then an adjustment amount of temperature of the residential water-heater load on node i participating in regulating at moment t is represented by
$${T}_{i , h ( rwh )}^{t ′} = {T}_{i , h ( rwh )}^{max} - {T}_{i , h ( rwh )}^{t} ;$$
wherein
$${T}_{i , h ( rwh )}^{t}$$
represents an upper-limit temperature set by the water heater when the user having residential water-heater load on node i not participating in regulating at moment t, and wherein a relationship between a vibration in state of charge
$$Δ SO {C}_{i , h ( rwh )}^{t ′}$$
and a vibration in power consumption
$$Δ {P}_{i , h ( rwh )}^{t ′}$$
corresponding to the adjustment amount of the residential water-heater temperature is expressed as:
$$\begin{matrix}Δ {SOC}_{i , h ( rwh )}^{t ′} = {SOC}_{i , h ( rwh )}^{t ′} - {SOC}_{i , h ( rwh )}^{t ′} \\ = 1 - \frac{{T}_{t , h ( rwh )}^{t}}{{T}_{t , h ( rwh )}^{max}}\end{matrix} ;$$
$$\begin{matrix}Δ {SOC}_{i , h ( rwh )}^{t + 1 ′} = {SOC}_{i , h ( rwh )}^{t + 1 ′} - {SOC}_{i , h ( rwh )}^{t + 1} \\ = {a}_{t} Δ {SOC}_{i , h ( rwh )}^{t ′} - \frac{{b}_{t}}{{T}_{i , h ( rwh )}^{max}} Δ {P}_{i , h ( rwh )}^{t ′}\end{matrix} ;$$
wherein
$${SOC}_{i , h ( rwh )}^{t}$$
represents a state of charge of a water heater corresponding to
$${T}_{i , h ( rwh )}^{t}$$
when the residential water-heater load on node i does not participates in regulating at moment t;
$${SOC}_{i , h ( rwh )}^{t ′}$$
represents a state of charge of the water heater corresponding to
$${T}_{i , h ( rwh )}^{max}$$
when the residential water-heater load on node i completely participates in regulating at moment t; aₜ and bₜ represent unit parameters of a water-heater modular unit, respectively; and
$$Δ {SOC}_{i , h ( rwh )}^{t + 1 ′} , {SOC}_{i , h ( rwh )}^{t + 1 ′} , and {SOC}_{i , h ( rwh )}^{t + 1}$$
represent a state of
$$Δ {SOC}_{i , h ( rwh )}^{t + 1 ′}$$
at moment t+1, a state of
$${SOC}_{i , h ( rwh )}^{t + 1 ′}$$
at moment t+1, and a state of
$${SOC}_{i , h ( rwh )}^{t}$$
at moment t+1, respectively.

3. The scheduling method for addressing power shortages according to claim 2, wherein in step S4, the aggregating regulating abilities of the Class II load comprises:
determining a space formed by an aggregated power adjustment range of the Class II load as R²ⁿ; wherein n represents a number of flexible resources;
solving a projection by using a vertex search method, wherein the projection is a feasible region of a convex polygon by changing optimization directions of an objective function, solving optimization problems under different objective functions, and gradually extrapolating and obtaining a boundary of the convex polygon; wherein an objective function for solving the projection is expressed as:
$$max \{ μ {x}_{pcc}^{t} , {x}_{pcc}^{t} ∈ {Ω}_{pcc}^{t} \} ;$$
wherein μ=(μ_{P}, μ_{Q}) represents a direction vector in space R² and is determined by a normal vector of a boundary of an initial convex polygon;
$${x}_{p c c}^{t} = {( {P}_{p c c} , {Q}_{p c c} )}^{T}$$
represents a point within a feasible region
$${Ω}_{p c c}^{t} ;$$
P_{pcc} and Q_{pcc} represent a projected active power and a projected reactive power on a connection circuit between an aggregrate and a power grid, respectively;
wherein constraints for solving the projection comprise constraints of adjustable output force and power flow constraints of a connected network of each flexible resource;
solving an optimization problem and searching for a new vertex along a direction of a normal vector of each edge of the initial convex polygon; wherein when a distance lₖ between the new vertex and an original edge is less than a constant value l_{δ}, a process of the solving is ended, and a condition of ending is expressed as:
$${l}_{k} = \frac{\vert M \cdot {P}_{pcc 0} + N \cdot {Q}_{pcc 0} + C \vert}{\sqrt{{M}^{2} + {N}^{2}}} \leq {l}_{δ} ;$$
wherein
$${x}_{pcc 0}^{t} = ( {P}_{pcc 0} , {Q}_{pcc 0} )$$
represents a coordinate of the new vertex; parameters M, N, and C are determined by a primary-side equation M·P_{pcc0}+N·Q_{pcc0}+C=0 and P_{cc0} and Q_{pcc0} represent newly solved projected active power and newly solved projected reactive power on the connection circuit between the aggregate and the power grid, respectively.

4. A scheduling system for addressing power shortages, configured for performing the method according to claim 1, comprising:
a resource classification module, configured for classifying demand-side flexible resources, wherein the demand-side flexible resources comprise Class I load and Class II load;
a scheduling-mechanism construction module, configured for constructing a day-ahead-and-intraday optimization scheduling mechanism for demand-side resources to participate in system regulating according to a classification result of demand-side flexible resources;
a resource modeling module, configured for modeling demand-side flexible resources, wherein the modeling comprises constructing a model of the Class I load and a model of the Class II load;
an adjustment capability aggregation module, configured for aggregating regulating abilities of the Class II load; and
an intraday optimization scheduling model module, configured for constructing an intraday optimization scheduling model based on a total cost of purchasing electricity from other power grids and a total cost of dispatching load-side resources.

5. A scheduling system for addressing power shortages, configured for performing the method according to claim 2, comprising:
a resource classification module, configured for classifying demand-side flexible resources, wherein the demand-side flexible resources comprise Class I load and Class II load;
a scheduling-mechanism construction module, configured for constructing a day-ahead-and-intraday optimization scheduling mechanism for demand-side resources to participate in system regulation according to a classification result of demand-side flexible resources;
a resource modeling module, configured for modeling demand-side flexible resources, wherein the modeling comprises constructing a model of the Class I load and a model of the Class II load;
an adjustment capability aggregation module, configured for aggregating regulating abilities of the Class II load; and
an intraday optimization scheduling model module, configured for constructing an intraday optimization scheduling model based on a total cost of purchasing electricity from other power grids and a total cost of dispatching load-side resources.

6. A scheduling system for addressing power shortages, configured for performing the method according to claim 3, comprising:
a resource classification module, configured for classifying demand-side flexible resources, wherein the demand-side flexible resources comprise Class I load and Class II load;
a scheduling-mechanism construction module, configured for constructing a day-ahead-and-intraday optimization scheduling mechanism for demand-side resources to participate in system regulating according to a classification result of demand-side flexible resources;
a resource modeling module, configured for modeling demand-side flexible resources, wherein the modeling comprises constructing a model of the Class I load and a model of the Class II load;
an adjustment capability aggregation module, configured for aggregating regulating abilities of the Class II load; and
an intraday optimization scheduling model module, configured for constructing an intraday optimization scheduling model based on a total cost of purchasing electricity from other power grids and a total cost of dispatching load-side resources.

7. A computer device comprising a processor and a memory storing a computer program, wherein when the processor executes the computer program, steps of the scheduling method for addressing power shortages according to claim 1 are implemented.

8. A computer device comprising a processor and a memory storing a computer program, wherein when the processor executes the computer program, steps of the scheduling method for addressing power shortages according to claim 2 are implemented.

9. A computer device comprising a processor and a memory storing a computer program, wherein when the processor executes the computer program, steps of the scheduling method for addressing power shortages according to claim 3 are implemented.

10. A non-transitory computer-readable storage medium storing a computer program, wherein when the computer program is executed by a processor, steps of the scheduling method for addressing power shortages according to claim 1 are implemented.

11. Anon-transitory computer-readable storage medium storing a computer program, wherein when the computer program is executed by a processor, steps of the scheduling method for addressing power shortages according to claim 2 are implemented.

12. A non-transitory computer-readable storage medium storing a computer program, wherein when the computer program is executed by a processor, steps of the scheduling method for addressing power shortages according to claim 3 are implemented.
